(19) United States
(12) Patent Application Publication
(10) Pub. No.: US 2008/0066740 A1
(43) Pub. Date: Mar. 20, 2008

(54) Animal treatment enclosure

(75) Inventor: Vern W. Hintergardt, Wellington, CO (US)

Correspondence Address: CR MILES, P.C.;CRAIG R. MILES, 405 MASON COURT, SUITE 119, FORT COLLINS, CO, 80524, US

(73) Assignee: Shiloh, LLC

(21) Appl. No.: 11/900,162

(22) Filed: Sep. 10, 2007

Related U.S. Application Data
(60) Provisional application No. 60/844,965, filed on Sep. 15, 2006.

(51) Int. Cl. A61D 7/00; A61D 99/00

(52) U.S. Cl. 128/200.14; 119/751; 604/23

(57) ABSTRACT

An animal treatment enclosure which defines an enclosed space in which a species of animal has a location and which receives a fine mist entrained in a flow of gas which flowably engages a part of the species of animal.

This United States patent application claims the benefit of U.S. Provisional Patent Application No. 60/844,965, filed Sep. 15, 2006.

### I. BACKGROUND

An animal treatment enclosure which defines an enclosed space in which a species of animal has a location and which receives a fine mist entrained in a flow of gas which flowably engages a part of the species of animal.

In veterinary medicine it can be preferred to administer medication(s) or material(s) to animals in the form of a liquid mist or vapor to treat the respiratory airways and introduce certain medications to the blood stream by transfer across respiratory membranes. Additionally, the hair and skin of animals can benefit from treatment with liquid mist.

A significant problem with conventional treatment with vaporized medicine(s) or material(s) can be that it is delivered through a mouth piece or inhaler piece which inserts into the mouth of the animal or is delivered through a mask which surrounds a part of the mouth, or nose, or both the mouth and nose of the animal. Understandably, as to certain species of animals such as insects, amphibians, reptiles, or birds a mouth piece or mask to deliver vaporized medicine(s) or material(s) has yet to be produced or the use of a mouth piece or mask to deliver vaporized medicine(s) or material(s) would be impossible or impractical.

Another significant problem with conventional treatment with vaporized medicine(s) or material(s) can be that there is no delivery device yet produced which delivers vaporized medicine(s) or materials(s) to flowably engage substantially the entire external surface area of animals such as insects, amphibians, reptiles, or birds.

The present inventive animal treatment enclosure addresses each of these problems with both devices and methods for the treatment of animals.

### II. SUMMARY OF THE INVENTION

Accordingly, a broad object of the invention can be to provide an animal treatment enclosure in which a species of animal can be located to be flowably engaged with vaporized medication(s) or material(s).

Another broad object of the invention can be to provide an animal treatment enclosure which in part generates vaporized medication(s) or material(s) which are received in the enclosed space of the animal treatment enclosure and can further flowably engage with substantially the entire external surface of the animal located within the enclosed space.

Another broad object of the invention can be to provide a method of treating substantially the entirety of an animal by locating an animal within an enclosed space and delivering vaporized medications(s) or material(s) to the enclosed space to flowably engage substantially the entirety of the external surface of the animal with the vaporized medication or treatment.

Naturally, further objects of the invention are disclosed throughout other areas of the specification, drawings, photographs, and claims.

### III. A BRIEF DESCRIPTION OF THE DRAWINGS

FIG. 1 is an illustration of a particular method of treating an animal in the enclosed space of particular embodiment of the invention.

FIG. 2 provides a perspective view of a particular embodiment of the invention having a releasably sealable access element in the open condition.

FIG. 3 provides top view of a particular embodiment of the invention having a releasably sealable access element in the closed condition.

FIG. 4 provides a front view of a particular embodiment of the invention.

FIG. 5 provides a side view of a particular embodiment of the invention.

FIG. 6 provides a top view of a second particular embodiment of the invention.

FIG. 7 provides a front view of said second particular embodiment of the invention.

FIG. 8 provides a side view of said second particular embodiment of the invention.

### IV. DETAILED DESCRIPTION OF THE PREFERRED EMBODIMENTS

An animal treatment enclosure which defines an enclosed space in which a species of animal has a location and which receives a fine mist entrained in a flow of gas which flowably engages at least a part of the species of animal.

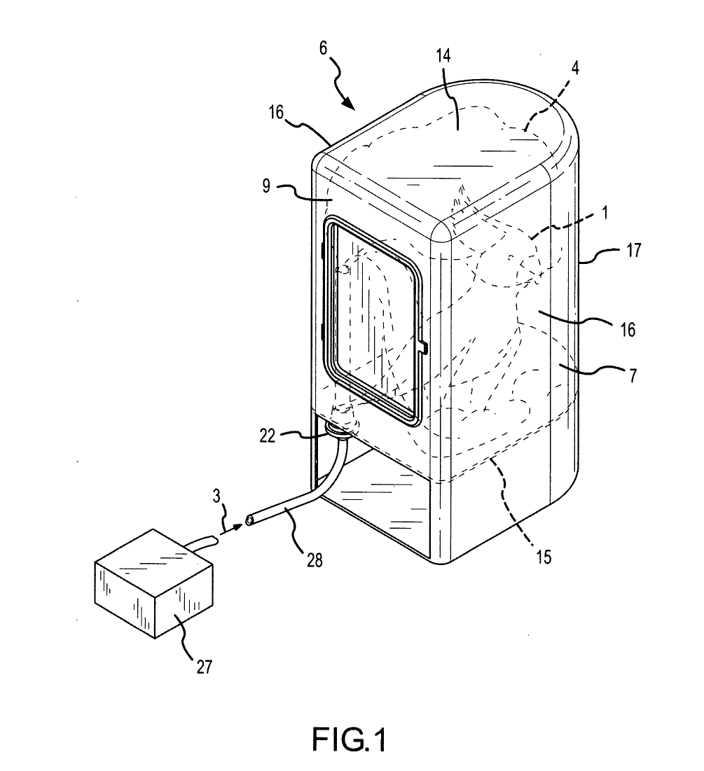

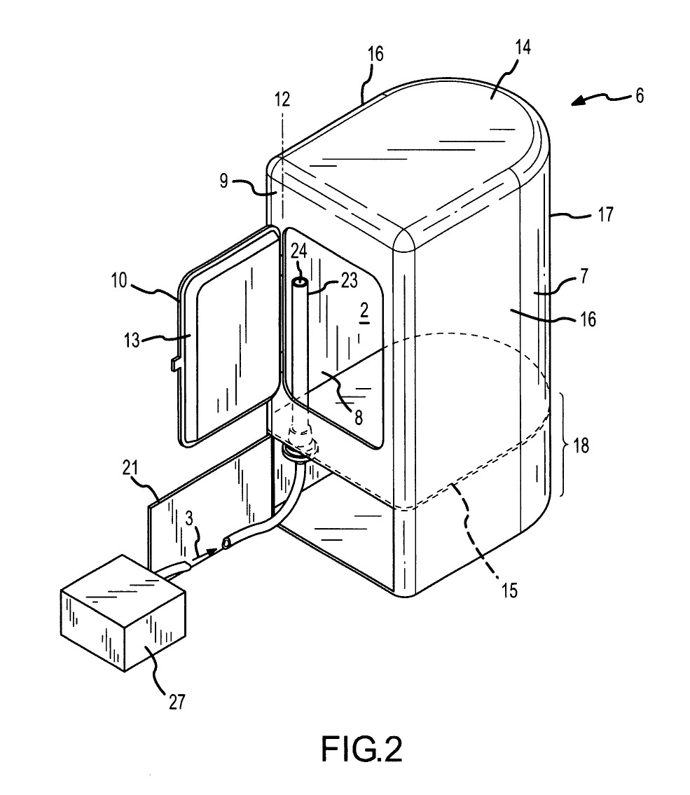

Now referring primarily to FIG. 1, a non-limiting method of treating a species of animal (1) is shown. A species of animal (1) can be located within an enclosed space (2). By generating a flow of gas (3) which entrains a fine mist (4), the fine mist (4) can be received in the enclosed space (2)(see FIG. 2) to flowably engage at least a part of the species of animal (1) located within the enclosed space (2).

While FIG. 1 shows a bird located within the enclosed space (2), this example is not intended to limit the numerous and wide variety of animals which can be treated within the enclosed space (2) and without limitation any species of mammal, species of reptile, species of amphibian, species of bird, or species of insect can be treated within the enclosed space (2).

The enclosed space (2), as to certain embodiments of the method, can encompass a greater or a lesser volume to allow the species of animal (1) treated to be entirely located therein (such that no substantial part of the animal extends outside of, or beyond the boundary of, the enclosed space (2)).

While the flow of gas (3) can typically be air, the flow of gas (3) can comprise any purified gas, desired mixture of gases, or partial pressures of gases which can be received by the enclosed space (2) to flowably engage a part of a species of animal (1) therein (whether continuously, at intervals of greater or lesser periods of duration, in lesser or greater amounts of gas flow, or the like) by contact with the external surface area of the species of mammal (whether skin, hair, feathers, or the like), inhalation, or respiration (whether active or passive respiration). The flow of gas (3) can be adjusted to have a gas flow rate in which the fine mist (4) can be entrained and delivered with the flow of gas (3) to the enclosed space.

The fine mist (4) can be generated from an amount of liquid (5) divided into sufficiently small droplets to be entrained in the flow of gas. The droplets entrained as the fine mist (4) in the flow of gas (3) may be of lesser or greater size depending upon the liquid, the gas flow, and the gas flow rate, the gas flow path to the enclosed space (2), or similar factors. In certain applications of the invention, the fine mist can be an amount of the liquid (5) in evaporative equilibrium with the flow of gas (3), or as to other applications of the invention, the fine mist (4) can entrain droplets of sufficient size to generate a fog, vapor, or haze or other perceivable amount of the liquid (5) within the flow of gas (3) received by the enclosed space (2). Numerous and varied liquids (5)(or materials solublized in an amount of liquid) can be evaporated, or divided into sufficiently small droplets, to be entrained by the flow of gas (3) and without limitation can include water; or medications such as gentocin, meloxicam, enrofloxacin, clomitrazole, or the like; or medications or other materials combined with or solubilized in water; or other liquids or materials in liquids in various permutations and combinations.

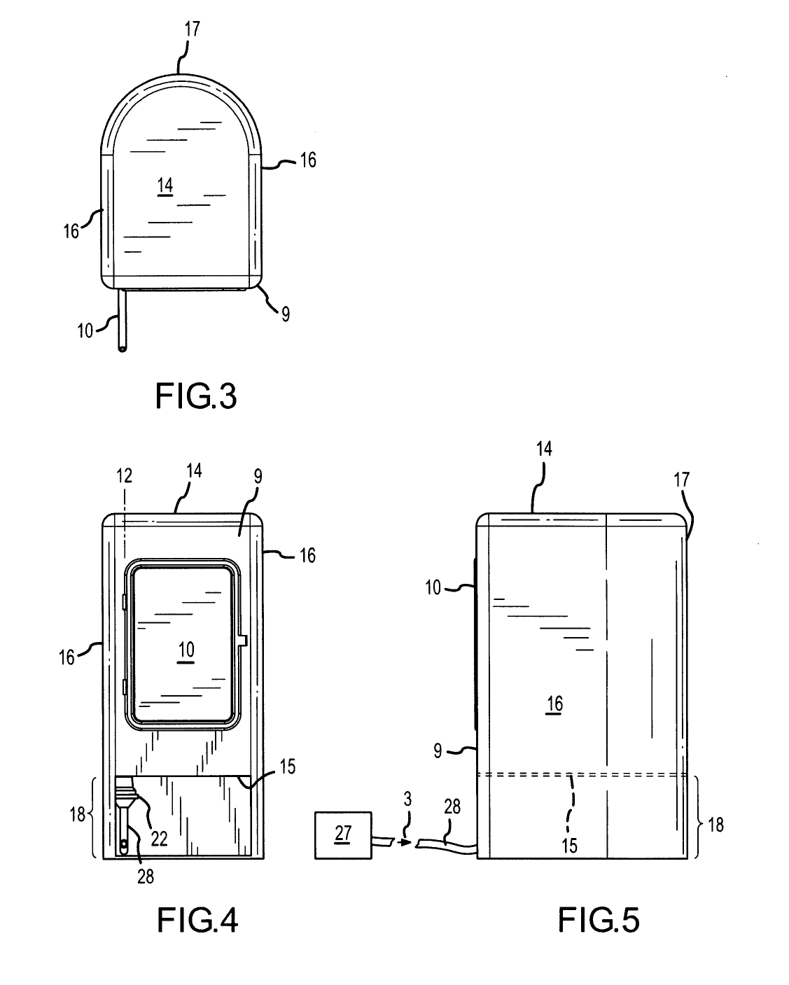

Now referring primarily to FIGS. 2-5, a particular embodiment of the animal treatment enclosure (6) can include an enclosure (7) which provides an internal wall (8) configured to define the boundary of the enclosed space (2). The enclosure (7) can be generated from a wide variety of materials such as polycarbonate plastic through which the species of animal (1) located in the enclosed space (2) can be visually observed. However, this example of a material from which the enclosure can be generated is not intended to be limiting with respect to the range of materials, such as polystyrene plastic, acrylic plastic, polypropylene plastic, or the like, from which the enclosure (7) can be configured by molding, fabrication, or other manner of configuring the material or configuring a plurality of materials. As above discussed, the enclosure (7) can be configured to bound an enclosed space (2) of greater or lesser volume, or having greater or lesser dimensions, depending upon the species of animal(s)(1) to be located within the enclosed space (2).

The embodiment of the enclosure (7) shown in FIGS. 1-5 further includes a front enclosure panel (9) having a releasably sealable access element (10) which can operate between a closed condition as shown for example in FIGS. 1, 3-5 and an open condition as shown for example in FIG. 2. The releasably sealable access element (10) can have a wide variety of configurations which can releasably seal with a comparably wide variation in access aperture (11) configurations. As to certain embodiments of the animal treatment enclosure (6), the releasably sealable access element (10) can comprise substantially the entire area of the front enclosure panel (9) and as to other embodiments of the animal treatment enclosure (6) the releasably sealable access element (10) may comprise only a portion of the area of the front enclosure panel (9). The releasably sealable access element (10) can be rotatably coupled to the front enclosure panel (9) as shown in FIGS. 2-5, or alternately can be a discrete part which releasably seals with the front enclosure panel (9) by the use of a variety of mechanical hardware such as screws, clasps, mateable parts of hook and loop such as VELCRO, eyelets and hooks, or the like, or by interlocking configuration of the releasably sealable access element (10) with the access aperture (11). As to those embodiments of the animal treatment enclosure (6) which rotatably couple the releasably sealable access element (10) to the front enclosure panel (9), travel can be generated about a rotation axis (12) (whether in a vertical or horizontal orientation, or other orientation) to locate the front enclosure panel (9) at a location between a fully open condition and a fully closed condition. The releasably sealable access element (10) can further include a relief element (13) which projects outwardly a distance from the surface of the releasably sealable access element (10) configured to insert into the access aperture (11) when the releasably sealable access element (10) is in the closed condition.

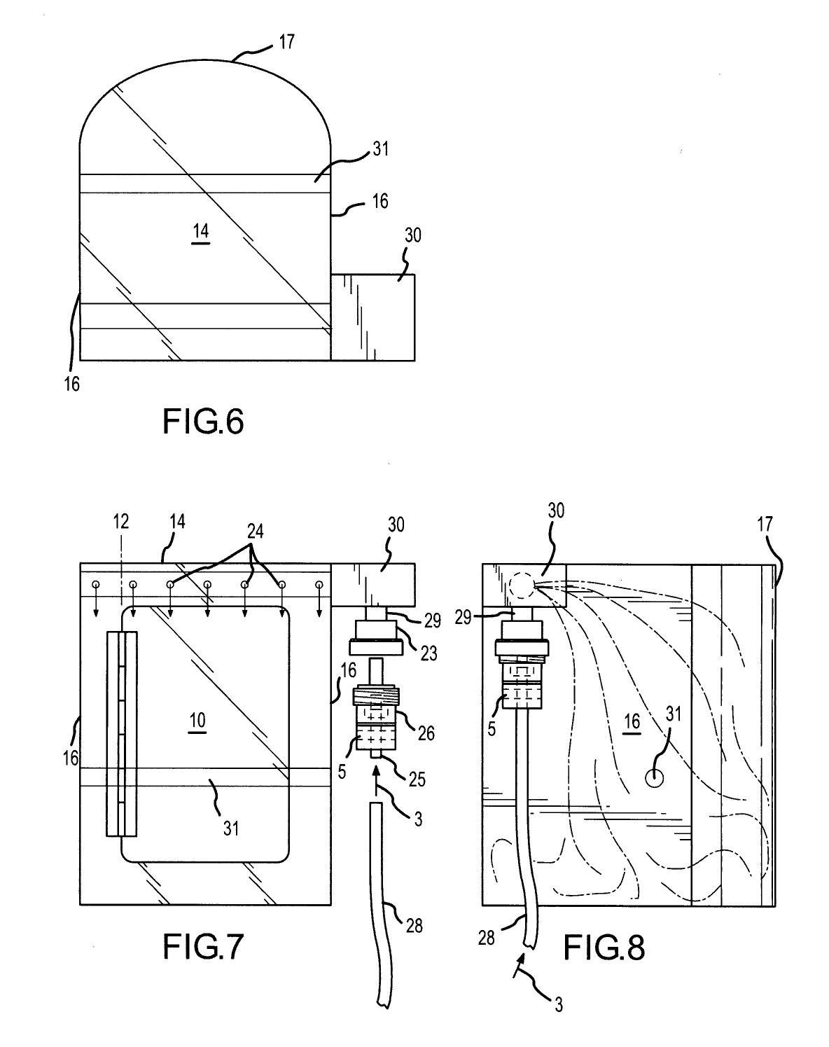

Again referring primarily to FIGS. 2-5, the animal treatment enclosure can further include a top panel (14), a bottom panel (15), a pair of side panels (16), and a back panel (17) all interconnected to generate an enclosure (7) which provides the internal wall (8) configured to define the boundary of the enclosed space (2). As shown in the figures the back panel (17) can be configured to provide a curved or an arcuate surface. However, the configuration of the panels shown in the Figures is not intended to limit the invention to the particular configurations shown in FIGS. 2-5 (or as shown in FIGS. 6-8), but rather the Figures are intended to provide a sufficient number of examples for the person of ordinary skill to make the numerous and varied configurations of the animal treatment enclosure (6) to treat the wide range of animal species above-discussed. A animal support (31) can be located inside the enclosure (7) to assist in locating the species of animal (1) in the enclosed space (2). For birds, as an example, the animal support (31) can comprise a perch to assist in locating a bird within the enclosed space (2).

Now referring specifically to FIGS. 2-5, embodiments of the animal treatment enclosure can further provide a base portion (18) which couples to the animal treatment enclosure (6)(whether as an integral or discrete element). The base portion (18) can further provide a second enclosed space (19). The second enclosed space (19) can further include a base access aperture (20) which can further provide a base access element (21) having one or more of the coupling, connecting, or relief elements above-discussed. As shown in FIGS. 6-8, embodiments of the animal treatment enclosure (6) can provide all or a portion of the above-discussed elements without the base portion (18).

Now referring to FIGS. 1-8, the animal treatment enclosure (6) further includes a treatment delivery conduit (23) having at least one treatment delivery conduit aperture (24) within an enclosed space (2) defined by the internal wall (8) of the enclosure (7). As shown by FIGS. 1-5, one embodiment of the animal treatment enclosure (6) provides a treatment delivery conduit (23) which penetrates the bottom panel (15) of the enclosure (7) and extends a distance vertically within the enclosed space (2) to terminate at one treatment delivery aperture (24). Alternately, as shown in FIGS. 6-8, the treatment delivery conduit (23) can penetrate one of the pair side panels (16) and extend a distance horizontally toward the opposing one of the pair of side panels (16) or extend between the opposing pair of side panels (16) to provide a plurality of treatment delivery apertures (24). With respect to both embodiments of the animal treatment enclosure shown in FIGS. 1-8, the flow of gas (3) which entrains the fine mist (4) can be received in the enclosed space (2)(see FIG. 2) by passage through the treatment delivery conduit (23) to flowably egress through at least one treatment delivery aperture (24).

Each embodiment of the animal treatment enclosure (6) can further provide a mist generator (22) connected to the treatment delivery conduit (23). The mist generator (22) operates to entrain a fine mist (4) as discussed above into the flow of gas (3) which can then be conducted by the treatment delivery aperture (23) to egress through the at least one treatment delivery aperture (24) into the enclosed space (2). While various mist generators (22) can be utilized with the varied embodiments of the animal treatment enclosure (6), a mist generator (22) suitable for use with embodiments of the animal treatment enclosure (6) shown in FIGS. 1-8 can be a disposable nebulizer as manufactured by Hudson RCI, Temecula, Calif. and distributed by Sunrise Medical, Somerset, Pa. See brochure 81454 entitled “Disposable Nebulizer”, hereby incorporated by reference herein. The fine mist can provide droplets entrained in said flow of gas having a diameter of between about 25 μm and about 500 μm, or a fine mist which contains droplets inhalable by the animal treated.

As shown in FIG. 7, an exemplary nebulizer can include a gas inlet (25) which directs the flow of gas (3) to contact an amount of liquid (5) located in a chamber (26) in a manner which entrains an amount of the liquid (5) as a fine mist (4) in the flow of gas (3), which as above-discussed, passes to the treatment delivery conduit (23) from a gas outlet (29). A gas flow generator (27) can be connected to the gas inlet (25) of the nebulizer or other mist generator (22) by a gas flow conduit (28). A flow of gas (3) can thereby pass from the gas flow generator (27) to the gas inlet (25) of the mist generator (23). A gas flow generator (27) suitable for use with embodiments of the animal treatment enclosure shown in FIGS. 1-8 can be a DeVilbiss Compressor “Pulmo-Aide 5650D” as distributed by Sunrise Medical, Somerset, Pa. See DeVilbiss catalog entitled “The DeVilbiss Family”, hereby incorporated by reference herein.

As shown in FIGS. 1, 2 and 4, the mist generator (22) can have a location in the base portion (18) coupled to the animal treatment enclosure (6). The gas flow conduit (28) coupled to the gas inlet (25) can egress from the second enclosed space (19) through the base access aperture (20) as shown. Alternately, as shown in FIGS. 7 and 8, the mist generator (22) can have a location external to the animal treatment enclosure (6) defined by the configuration of the treatment delivery conduit coupler (30) which functions to fluidicly couple the passage of the treatment delivery conduit (23) with the gas outlet (29) of the mist generator (22). While a limited number of locations of the mist generator (22) are shown in the Figures, embodiments of the animal treatment enclosure (6) are not so limited and the mist generator can be located in any manner sufficiently proximate to the treatment deliver conduit apertures (24) to avoid having the liquid (5) entrained by the flow of gas (3) transfer (by condensation or otherwise) from the flow of gas (3) prior to being received by the enclosed space (2) of the animal treatment enclosure (6).

As can be easily understood from the foregoing, the basic concepts of the present invention can be embodied in a variety of ways. The invention involves numerous and varied animal treatment enclosures and methods of treating animals within an enclosure.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “nebulizer” should be understood to encompass disclosure of the act of “nebulizing”—whether explicitly discussed or not—and, conversely, were there effectively disclosure of the act of “nebulizing”, such a disclosure should be understood to encompass disclosure of a “neblizer” and even a “means for nebulizing.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the animal treatment enclosures herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. An animal treatment enclosure, comprising:
a) an enclosure which defines an enclosed space accessible to removably locate entirely inside at least one animal;
b) a gas flow conduit having a gas flow path fluidicly coupled to said enclosed space;
c) a gas flow generator coupled to said gas flow conduit;
d) a flow of gas generated in said gas flow path of said gas flow conduit by said gas flow generator said flow of gas received by said enclosed space to flowably engage a part of said animal located entirely within said enclosed space; and
e) a mist generator fluidicly coupled to said gas flow conduit which entrains an amount of liquid in said flow of gas generated in said gas flow path of said gas flow conduit said amount of liquid entrained in said flow of gas received by said enclosed space.

2. The animal treatment enclosure as described in claim 1, wherein said animal is selected from the group consisting of: a mammalian species, an avian species, a reptile species, and an amphibian species, and an insect species.

3. The animal treatment enclosure as described in claim 1, wherein said mist generator comprises a nebulizer.

4. The animal treatment enclosure as described in claim 1, wherein said flow of gas entrains said amount of liquid as droplets received by said enclosed space as a fine mist.

5. The animal treatment enclosure as described in claim 4, wherein said fine mist comprises droplets entrained in said flow of gas having a diameter of between about 25 μm and about 500 μm.

6. The animal treatment enclosure as described in claim 1, wherein said flow of gas has an adjustable gas flow rate.

7. The animal treatment enclosure as described in claim 1, wherein said gas flow generator is selected from the group consisting of: a pressured tank of gas, a diaphragm pump, a piston pump.

8. The animal treatment enclosure as described in claim 1, further comprising an amount of medicament established in said amount of liquid.

9. The animal treatment enclosure as described in claim 8, wherein said medicament is selected from the group consisting of: gentocin, meloxicam, enrofloxacin, clomitrazole.

10. The animal treatment enclosure as described in claim 1, further comprising a treatment delivery conduit which locates at least one treatment delivery conduit aperture a distance inside said enclosed space.

11. The animal treatment enclosure as described in claim 10, wherein said treatment delivery conduit extends a distance vertically from the bottom of said enclosure to terminate in said treatment delivery aperture.

12. The animal treatment enclosure as described in claim 10, where said treatment deliver conduit extends a distance horizontally from the side of said enclosure to terminate in said treatment delivery aperture.

13. The animal treatment enclosure as described in claim 12, wherein said treatment delivery conduit extends horizontally between opposed sides of said enclosure and provides a plurality of treatment delivery apertures through which the enclosed space receives said flow of gas which entrains said amount of liquid.

14. A method of treating an animal, comprising the steps of:
a) locating said animal entirely inside an enclosed space of an enclosure;
b) generating a flow of gas in a gas flow conduit having a gas flow path fluidically coupled to said enclosed space;
b. entraining an amount of liquid in said flow of gas as a fine mist;
c. receiving said fine mist inside said enclosed space; and
d. flowably engaging a part of said animal located entirely inside said enclosed space with said fine mist.

15. The method of treating an animal as described by claim 14, wherein said step of locating said animal entirely inside an enclosed space of an enclosure comprises the step of locating an animal entirely inside said enclosed space of said enclosure selected from the group consisting of: a mammalian species, an avian species, a reptile species, and an amphibian species, and an insect species.

16. The method of treating an animal as described by claim 15, wherein said step of entraining an amount of liquid in said flow of gas as a fine mist comprises the step of entraining an amount of liquid in said flow of gas as an inhalable fine mist.

17. The method of treating an animal as described by claim 15, wherein said step of entraining an amount of liquid in said flow of gas as an inhalable fine mist comprises nebulizing said amount of liquid to entrain said amount in said flow of gas.

18. The method of treating an animal as described by claim 15, wherein said step of entraining an amount of liquid in said flow of gas as a fine mist comprises the step of entraining an amount of liquid in said flow of gas as an inhalable fine mist said inhalable fine mist providing droplets having a diameter of between about 25 μm and about 500 μm.

19. The method of treating an animal as described by claim 16, further comprising the step of inhaling said inhalable fine mist by said animal located entirely inside an enclosed space of an enclosure.

20. The method of treating an animal as described by claim 19, further comprising the step of establishing an amount of medicament in said inhalable fine mist inhaled by said animal.
